(19) United States
(12) Patent Application Publication
(10) Pub. No.: US 2015/0122709 A1
(43) Pub. Date: May 7, 2015

(54) WATER TREATMENT SYSTEM

(71) Applicant: Ismael Sosa-Sanchez, Victoria (AU)

(72) Inventor: Ismael Sosa-Sanchez, Victoria (AU)

(73) Assignee: ESA ENVIRO WATER (AUSTRALIA) PTY LIMITED, Victoria (AU)

(21) Appl. No.: 14/237,670

(22) PCT Filed: Aug. 2, 2012
(86) PCT No.: PCT/AU2012/000910

§ 371 Date: Jan. 21, 2015

(30) Foreign Application Priority Data
Aug. 5, 2011 (AU) 2011903118

(51) Int. Cl. C02F 9/00; C02F 11/04; C05F 17/00

(52) U.S. Cl. CPC C02F 9/00; C05F 17/0018; C02F 11/04; C02F 2003/001
USPC 210/85

(57) ABSTRACT

An apparatus for treating wastewater, comprising: (a) means for primary screening of solids from the wastewater to produce gross solids and screened wastewater containing waste solids, (b) means for sedimentation of solids from the screened wastewater to produce sedimented waste solids and a supernatant wastewater containing suspended solids, (c) means for filtration of solids from the supernatant wastewater to produce concentrated waste solids and a filtered wastewater containing organic material, (d) means for aerobic bioreaction of the organic material in the filtered wastewater to produce a sludge of waste solids and non-drinkable recycled water, (e) means for fixed media anaerobic bioreaction of the waste solids to produce methane gas and excess solids, (f) means for collecting and concentrating the excess solids to produce fertilizer, and/or a solid material with energy producing capacity, (g) means for remote continuous monitoring and controlling in real time of the operation of the apparatus.

### TECHNICAL FIELD

The present invention relates to apparatus and methods for treating wastewater and, in particular, to such apparatus and methods that utilise natural sources of treatment through various stages of sedimentation, filtration and bioreaction to produce a quality of recycled water in a very short time and using low energy, and that conforms to or exceeds Class A parameters of Australian water quality standards. More particularly, the present invention relates to improved micronutrient growth formulations and growth support media for promoting aerobic and anaerobic digestion of organic waste material during the course of such treatment.

The present invention also relates to the enhanced biological production of methane gas, which may be used in the generation of electrical power, and to the production of fertilizer from the operation of the apparatus and methods referred to herein.

Furthermore, the present invention relates to a secure and reliable system of remote continuous monitoring and controlling in real time of the operation of the apparatus and methods referred to herein, such as through a secure internet connection, which can be supplemented by automated SMS message alerts to the operator.

In this specification, the term “wastewater” is intended to refer to all kinds of water that, as a result of the treatment described herewithin, can attain or exceed the aforementioned Class A parameters. This includes, but is not limited to, bore water, leachate, factory wastewater, sewerage (black wastewater), grey water (such as commercial and domestic wastewater from laundry, car washing, hand basin, and shower/spa use), and water from rivers and lakes that may be polluted or suffering from an algal bloom. It will also be appreciated that the term “wastewater” may refer to water that includes pollutants or impurities in the form of solids in temporary or permanent suspension and dissolved organic or inorganic material.

### BACKGROUND ART

The relative scarcity of drinking water in the world and the continued rapid pace of world population growth and industrialisation, particularly in fast growing and emerging economies, that leads to depletion and destruction of natural resources, place heavy strains on drinking water security.

Most water available (70%) in the world is non-drinkable seawater. Of the remaining 30%, the water is contained in the form of clouds, lakes, rivers, ice/snow, and underground or bore water, not all of which is drinkable. The small percentage of readily available drinking water is very limited and the consequences of not looking after this resource properly can be detrimental to the health of people and the wellbeing of a country and its security.

Demand for drinking water is growing in many countries due to increased population pressures, and changing water use practices through increased standards of living and increased agricultural and industrial demand for clean water. They are driven by economic growth, particularly in fast growing economies like China and India.

This increased pressure on limited drinking water sources makes water security an integral part of a country's economy. Without water security, the economy of a country can suffer negatively and growth cannot be sustained. For this reason, present inefficient models of water use need to be replaced with greener alternatives that, not only use water more efficiently, but recycle used water using natural sources of waste treatment.

Conventional water treatment plants are many and varied to suit the kind of wastewater being treated. Industrial wastewater treatment plants tend to consume high levels of energy during their operation in proportion to the quantity of treated water produced, and may employ many artificial sources of filtration and bioreaction that themselves place pressure on energy supply and natural resources used in their manufacture.

They also produce gaseous pollutants or biogases. For example, methane is produced when organic matter in the effluent stream or other polluted water is digested anaerobically by microorganisms through a biological process called methanogenesis. Although some mitigation of the impact to the environment may be achieved by use of scrubbers or other greenhouse gas capture and storage technology, the methane is nonetheless lost back into the environment, and its capacity to serve as a source of electrical power is wasted.

Another byproduct of conventional water treatment plants is sludge or solid waste which has a high concentration of undigested organic material and minerals, and would normally be dried, incinerated or disposed of as land fill, thus depriving people of its use as a fertilizer, or as an energy source for heating or electricity generation.

It is also well appreciated that many of these water treatment plants require round-the-clock monitoring and control by a large number of staff who must be on hand at the plant. It is also common practice to sample the treated water on a daily or weekly basis and have such samples analysed at remote laboratories where the results may not be forthcoming for up to a week. Remote continuous monitoring and controlling for Class A parameters in real time of the operation of such plants which is efficient, reliable and secure is not yet available, and so there is a reliance on having a sufficient number of staff for their operation, which brings with it the requirement that the staff be properly supported and remunerated, thus adding to the costs of operating such plants.

### DISCLOSURE OF INVENTION

It is, therefore, an object of the present invention to overcome, or at least substantially ameliorate, the aforementioned disadvantages of the prior art.

According to the invention, there is provided an apparatus for treating wastewater comprising:
(a) means for primary screening of solids from the wastewater to produce gross solids and screened wastewater containing waste solids,
(b) means for sedimentation of solids from the screened wastewater to produce sedimented waste solids and a supernatant wastewater containing suspended solids,
(c) means for filtration of solids from the supernatant wastewater to produce concentrated waste solids and a filtered wastewater containing organic material,
(d) means for aerobic bioreaction of the organic material in the filtered wastewater to produce a sludge of waste solids and non-drinkable recycled water,
(e) optionally, means for desalinating the non-drinkable recycled water to produce drinkable, potable water,
(f) means for fixed media anaerobic bioreaction of the waste solids to produce methane gas and excess solids,
(g) means for collecting and concentrating the excess solids to produce fertilizer, and/or a solid material with energy producing capacity,
(h) means for remote continuous monitoring and controlling in real time of the operation of the apparatus.

### BRIEF DESCRIPTION OF THE DRAWINGS

FIG. 1A is a diagrammatic representation of an apparatus and method for treating wastewater according to a preferred embodiment of the invention showing the primary screening stage and the sedimentation stage. FIG. 1B is a diagrammatic representation of an apparatus and method for treating wastewater according to a preferred embodiment of the invention showing the filtration stage and the aerobic and fixed media anaerobic bioreaction stages.

FIG. 1C is a diagrammatic representation of an apparatus and method for treating wastewater according to a preferred embodiment of the invention showing the desalinating stage and a disinfection stage including chlorination.

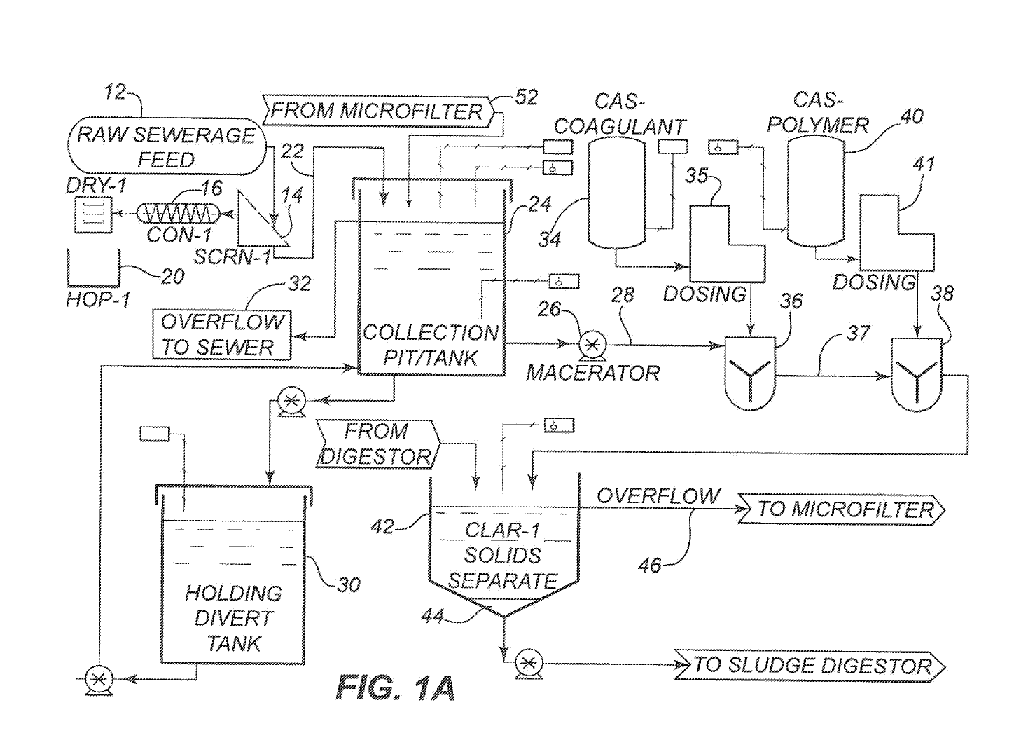

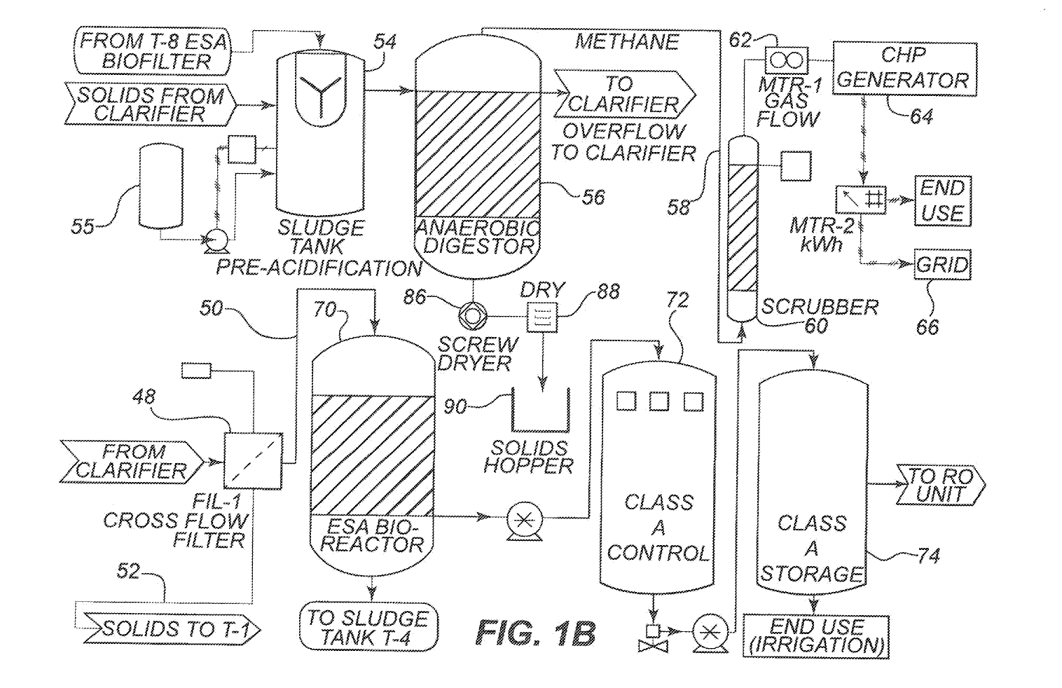

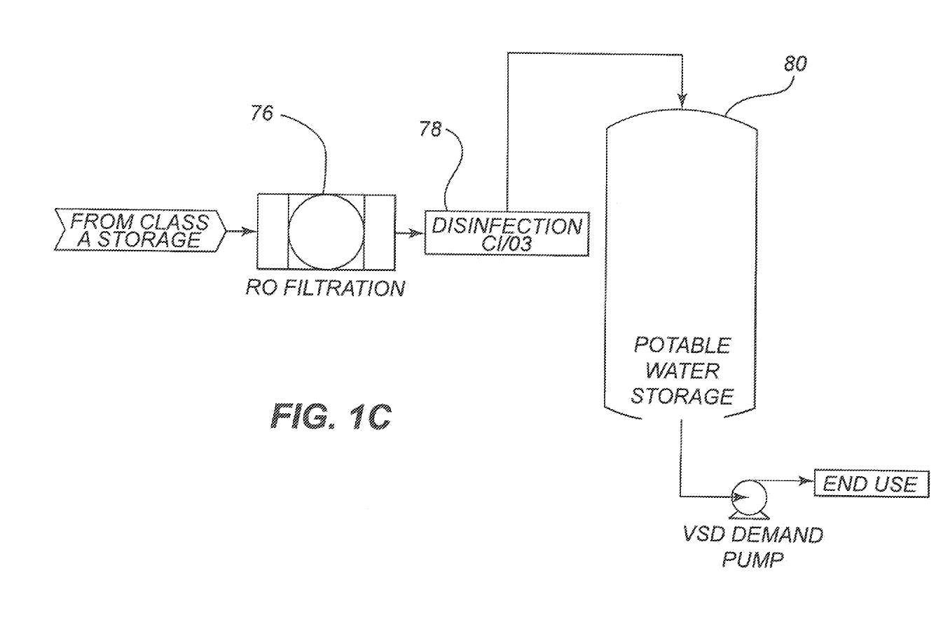

### MODES FOR CARRYING OUT THE INVENTION

Wastewater in the form of, for example, a raw sewerage feed 12 enters the system. A screen filter 14 removes gross solids using a screw conveyor mechanism 16, sending the screened solids into a drying chamber 18 which dries the gross solids before disposing them into a hopper or waste bin 20. The screened wastewater 22 then enters a tank or collection pit 24 with the level of the wastewater therein controlling its operation.

In order to facilitate sedimentation of solids from the screened wastewater 22, the wastewater is pumped from the collection pit 24 using a macerator pump 26 which breaks down the remaining waste solids contained in the screened wastewater into a slurry 28.

A secondary pit or holding tank 30 is used if excess wastewater enters the system and overfills the collection pit 24. The level of wastewater inside this tank 30 is controlled by the use of level switches. In the event that both the collection pit 24 and the holding tank 30 are full, the excess wastewater can overflow to a sewer 32. When required, wastewater inside tank 30 is pumped back into the collection pit 24.

The slurry 28 is subjected to a chemically assisted sedimentation (CAS) process, where a coagulant 34 at a required dose set by a dosing unit 35 is added to the slurry and a mixer is used to blend the coagulant 34 with the slurry in a mixing tank 36. The resulting coagulation creates larger particles which would normally tend to settle or be dispersed towards the bottom of the tank, however, the continuous blending or mixing ensures that such settling does not occur at this step in the CAS process. Instead, the coagulated slurry 37 moves by gravity into a second mixing tank 38 where a flocculant (polymer) 40 at a required dose set by a dosing unit 41 is added. The addition of flocculant 40 makes the suspended particles larger and heavier, and they are transferred into a settling tank 42 where sedimentation of solids occurs to produce sedimented waste solids 44 at the bottom of the tank and a relatively clear, almost solids free, supernatant wastewater 46 containing suspended solids.

In order to facilitate filtration of solids from the supernatant wastewater 46, the wastewater is transferred to a cross flow microfiltration (CFM) unit 48 or ultrafiltration (UF) unit that utilises membranes of, for example, 0.22 micron (or equivalent Dalton units) pore size to produce clear, filtered wastewater 50 which is free of solids but contains organic material. This microfiltration process also produces a concentrate of waste solids 52. The solids 52 are then transferred back to the collection pit 24 where they are again subjected to the above sedimentation and filtration stages.

The sedimented waste solids 44 at the bottom of the settling tank 42 are pumped into a sludge mixing tank 54 and subject to pre-acidification. They are then transferred into a fixed media anaerobic bioreactor tank 56 where the solids 44 are anaerobically digested by naturally occurring anaerobic microorganisms to produce biogas in the form of methane 58 and smaller amounts of other contaminating biogases.

A blend of micronutrients is added to the anaerobic bioreactor tank 56 to boost the production of biogas by a minimum of 50% when compared to standard anaerobic systems. This blend of micronutrients (to be described later in the specification) is used with a blend of biofiltration media upon which the anaerobic microorganisms are supported.

A useful four part blend of biofiltration media comprises porous granular activated carbon (GAC), porous zeolite, porous clay, and a plastic biological media. Other combinations of biofiltration media components are also useful.

The porous GAC is of particle size greater than 1.0 millimetre diameter. Two or more kinds of GACs can be used for this purpose in a concentration range of 25% to 40% of the volume of the blend. The porous zeolite is of a particle size greater than 1.0 millimetre diameter. Zeolites from different geographical locations can be used. The concentration of zeolite used in the blend is also from 25% to 40% of the volume of the blend. The porous clay is of a particular size greater than 5 millimetre diameter and is used in a concentration range of 15% to 25% of the volume of the blend. The plastic biological media can be of any suitable kind to constitute the balance required to make up the volume of the media to 100%.

An example of a blend of biofiltration media is as follows:

1 part fine GAC particles (15%)

1 part coarse GAC particles (15%)

1 part fine zeolite particles (15%)

1 part coarse zeolite particles (15%)

1 part porous fine clay particles (12.5%)

1 part porous coarse clay particles (12.5%)

1 part plastic biological media particles (15%)

Other combinations and percentages of suitable components of biofiltration media can also be used, such as ion exchange media, non-porous media, non-plastic media, glass media, peat and plant fibers, geotextiles, red mud filtration material, metallic media, “Teflon” media, PVC media, sand and other similar materials commonly used in water and wastewater filtration.

The components of the biofiltration media blend are all particles that can act as absorbents and/or adsorbents of pollutants present in wastewater. Different minerals and other particles in the blend have the ability to trap different kinds of pollutants. For example, zeolites preferentially absorb ammonia and other nitrogen based compounds, thereby removing them from the wastewater. As microorganisms can also grow in, and attach to, the biofiltration media, it is possible to have microorganisms growing next to absorbed and adsorbed pollutants, such that the microorganisms would then have the ability to access them as a source of food for their metabolism, growth and reproduction.

The blend of biofiltration media is stored in filter socks, which fixes the blend and keeps it from becoming loose inside the bioreactor tank 56. By ensuring that the biofiltration media stays fixed, the bioreactor tank 56 does not clog up or need backwashing, as is the common practice in many bioreactors of the prior art. Also, many existing bioreactors require daily or weekly biofiltration media recharge to compensate for the media losses caused by the hydraulic design of the treatment plants utilising such bioreactors.

The effective operational life of the biofiltration media described above for use in the present invention is expected to be at least ten years.

The growth and biological activity of microorganisms in the anaerobic bioreactor tank 56 is enhanced and methanogenesis is optimised by the addition of an aforementioned blend of micronutrients designed to create a more robust microbiological digestion process by enabling the microorganisms to adjust to the wastewater.

The micronutrients are selected on the basis that they can be used by anaerobic microorganisms for the effective transformation of volatile fatty acids (VFAs) into methane gas. These micronutrients include metal ions, that may be free or present in a compound, and that are required by enzymes present in anaerobic microorganisms, such as iron (Fe), nickel (Ni), cobalt (Co) and molybdenum (Mo). These metal ions are blended and chelated using a solution of EDTA, at a pH ranging between 9.5 and 10.5, and a solution of citric acid at a pH ranging between 6.5 and 7.5.

These micronutrients work effectively when present in a blend at minimum ratios of 100 nM Fe, 100 nM Ni, 50 nM Co and 50 nM Mo, and added to the slurry fed into sludge mixing tank 54 via a dosing pump 55.

The chelating process is carried out by dissolving 5 kg of EDTA in 100 litres of tap water, and then adding, in this order and at mixing intervals of 15 to 30 minutes between additions, iron, molybdenum, cobalt and nickel. The pH is then reduced to a more neutral level (of between pH 6.5 and 7.5) by the addition of citric acid, which also chelates the compounds.

The chelating agents EDTA and citric acid make the metal ions readily available for the microorganisms to take up and use. Once the microorganisms have adjusted to the wastewater, the addition of further micronutrients is required only at intervals equivalent to three sludge ages, as the microorganisms will in the meantime be robust enough to grow in the wastewater being treated, thereby optimising methanogenesis.

As is well appreciated in the art, the biological production of methane gas is carried out by the methanogens, a group of microorganisms belonging to the Archaea domain. These microorganisms account for most of the methane production in anaerobic conditions and processes designed to treat wastewater laden with organic material.

A limited number of substrates can be converted to methane, and most methanogens are capable of utilising only one or two methanogenic substrates. Among the well known methanogenic substrates are acetate and a variety of C-1 substrates (single carbon containing compounds) such as carbon dioxide, methanol and various methylamines and methylsulfides. Most organic material in wastewater can be gradually converted to methanogenic substrates, which can then be converted to methane under anaerobic conditions.

The ability of methanogens to effectively convert those substrates to methane depends on the availability of adequate coenzymes, biofactors and cofactors, which are the catalysts of methane production.

The formation of those coenzymes, biofactors and cofactors depends on the bioavailability of vitamins and minerals, which increase the effectiveness and the robustness of the methanogens for methane production, resulting in greater reduction in the concentration of organic material or organic load (as usually measured by the Biochemical Oxygen Demand or BOD), with subsequent cleaner water being produced.

Methanogens only require very small amounts of vitamins and minerals to improve their metabolic capabilities.

Micronutrient dosing rates of the micronutrient blends are tailored on the basis of determining the flow rate versus organic load (BOD) in the wastewater. An analysis of the wastewater parameters is required to provide the most appropriate and economic dosing rates to establish and maintain robust methanogen populations in anaerobic conditions.

Micronutrient dosing rates are adjusted to suit changes in process effectiveness. For example, less micronutrients are required as the anaerobic bioreactor tank recovers and new methanogens become established in the anaerobic conditions.

The methane and smaller amounts of other contaminating biogases produced in the anaerobic bioreactor tank 56 are then subjected to a scrubber type filter 60 to remove as much of the contaminating gases as possible.

A gas metre 62 is used to measure how much gas is produced by the system.

A CHP generator 64, coupled to a hybrid biodiesel/biogas generator, is used to produce electricity from the generated biogas, and this electricity can then be used locally (for example, to power the treatment plant) or be exported to a power grid 66.

The amount of electrical power that can be produced by this process will vary depending on the kind of wastewater being treated, but it is at least 50% more than existing biogas producing anaerobic bioreactor processes.

If a power grid is not available, the methane can be harvested and used to run boilers or can be used for cooking or in domestic hot water units, for example.

The clear, filtered wastewater 50 produced by the cross-flow microfiltration (CMF) unit 48, although solids free, still contains organic material at very low levels. This wastewater 50 is further treated to remove the organic material in an aerobic bioreactor tank 70 where the organic material is digested by naturally occurring aerobic bacteria to produce Class A parameters recycled water. Class A parameters recycled water can be used for any non-drinking applications inside or outside a building and it represents a very low health risk to its users.

The aerobic bioreaction allows for different biological processes to occur simultaneously, e.g. nutrient removal, aerobic, anoxic and anaerobic processes. The aerobic bioreaction conditions include, but are not limited to, trickling, submersed, nutrient removal, and activated sludge processes, all within one tank.

In order to enhance the aerobic growth of the naturally occurring bacteria present in the bioreactor tank 70, the aerobic bioreactor tank 70 utilises similar biofiltration media and similar micronutrients as are used in the anaerobic process described above. The micronutrient dosing ratios are determined by the Chemical Oxygen Demand (COD) and/or BOD, and nitrogen and phosphorous concentrations present in the wastewater.

The non-drinkable, recycled water produced by this process is pumped into a temporary storage and monitoring tank 72 where its quality is monitored in real time to ensure it retains Class A parameters as required under Australian EPA and Health Department guidelines.

The water is then pumped into a storage tank 74 where it is indefinitely stored for future use.

Optionally, the water from storage tank 74 is subjected to desalination using a reverse osmosis filtration unit 76 or an ultrafiltration (UF) unit to produce drinkable, potable water.

This water can then be disinfected with ultraviolet (UV) radiation or ozone, and then be chlorinated by a chlorination unit 78 to comply with World Health Organisation (WHO) drinking water standards and stored in a potable water storage tank 80. This option can be taken in countries or in circumstances where the production of drinking water from recycled water is allowed.

Any excess solids 82 produced in the aerobic bioreactor tank 70 are transferred to the sludge mixing tank 54 for further processing and digestion in the anaerobic bioreactor tank 56.

Any excess solids 84 produced in the anaerobic bioreactor tank 56 are sent into a screw dryer 86 and then into a drying chamber 88 which dries the excess solids before disposing them in a solids hopper 90.

The dried excess solids may be pelletized for use as a fertilizer or other useful by-product, such as a solid material with energy producing capacity (e.g. fuel pellets), depending on the source of wastewater being treated.

The system is controlled and tested for quality parameters required for recycled water, like BOD, suspended solids, turbidity, E.Coli, viruses, parasites, pH, residual chlorine, etc. and is subject to real time monitoring and data gathering on water quality, biogas production and electricity production. All these parameters are checked on-line and can be viewed and managed from any remote computer with secure internet connection anywhere in the world. This system automatically sends SMS alarm messages when an emergency occurs. Also, if there are compliance questions regarding water quality, biogas production or electricity production, stored data can be retrieved to show plant performance history for these variables.

It is an advantage of the present invention that it utilises a blend of micronutrients that enhance and prolong the growth of anaerobic microorganisms, making them more robust and more efficient at converting organic material into biogas.

In contrast, prior art wastewater treatment systems take the approach of re-seeding bioreactors with anaerobic sludges from other bioreactors or with liquid cultures of microorganisms, but this re-seeding approach requires the microorganisms to adjust immediately to new bioreaction conditions, with the potential for subsequent death of the microorganisms in the anaerobic sludge or liquid culture, as commonly occurs in prior art systems.

Specific advantages stemming from the use of the micronutrient blend in each of the anaerobic and aerobic bioreactor tanks are:
increased sludge digestion activity in anaerobic conditions
increased biogas production (including increase in methane production by a minimum of 50% with the potential for 100% increase)
faster bioreaction times, and therefore smaller size required for bioreactors
lower Biochemical Oxygen Demand in treated wastewater
lower amount of waste solids (sludge) produced by the system, thus decreasing the total solids in the treated water
natural micronutrients avoid classification as hazardous under Occupational Health and Safety guidelines, allowing easier and safer transport and use.

The system of the present invention can be placed above ground, in which event it requires only about one-third of the land required for prior art wastewater treatment plants that produce recycled water conforming to Class A parameters of Australian water quality standards, or can be placed underground with the use of pits, special tanks, equipment and stacks.

The system of the present invention is also modular in overall design, thus enabling the sizing up or down of the system to suit production targets or fast population growth.

Various other advantages of the present invention will be apparent to persons skilled in the art, and particularly the advantageously greater speed of reaction of the system to produce recycled water conforming to Class A parameters of Australian water quality standards at very low energy requirements when compared to prior art systems.

It will also be apparent to persons skilled in the art that various modifications in details of design and construction of the wastewater treatment system described above may be made without departing from the scope or ambit of the present invention.

### INDUSTRIAL APPLICABILITY

The present invention has industrial applicability in the wastewater treatment and sewerage treatment industries.

1. An apparatus for treating wastewater, comprising:
(a) means for primary screening of solids from the wastewater to produce gross solids and screened wastewater containing waste solids,
(b) means for sedimentation of solids from the screened wastewater to produce sedimented waste solids and a supernatant wastewater containing suspended solids,
(c) means for filtration of solids from the supernatant wastewater to produce concentrated waste solids and a filtered wastewater containing organic material,
(d) means for aerobic bioreaction of the organic material in the filtered wastewater to produce a sludge of waste solids and non-drinkable recycled water,
(e) means for fixed media anaerobic bioreaction of the waste solids to produce methane gas and excess solids,
(f) means for collecting and concentrating the excess solids to produce fertilizer, and/or a solid material with energy producing capacity,
(g) means for remote continuous monitoring and controlling in real time of the operation of the apparatus.

2. The apparatus of claim 1 further comprising means for desalinating the non-drinkable recycled water to produce drinkable, potable water.

3. The apparatus of claim 1 wherein the means for sedimentation of solids from the screened wastewater comprises means for mixing a predetermined dose of coagulant to the screened wastewater to produce a coagulated slurry, and means for mixing a predetermined dose of flocculants to the coagulated slurry to produce waste solids.

4. The apparatus of claim 3 further comprising a settling tank for allowing sedimentation of the waste solids.

5. The apparatus of claim 1 wherein the means for filtration of solids from the supernatant wastewater comprises a cross flow microfiltration unit or ultrafiltration unit to produce filtered wastewater containing organic material.

6. The apparatus of claim 1 wherein the means for fixed media anaerobic bioreaction of the waste solids comprises an anaerobic bioreactor tank containing naturally occurring anaerobic microorganisms supported upon a blend of biofiltration media comprising particles which absorb and/or adsorb pollutants in the wastewater.

7. The apparatus of claim 6 wherein the anaerobic bioreactor tank further contains a blend of micronutrients which are used by the anaerobic microorganisms to transform volatile fatty acids into methane gas.

8. The apparatus of claim 7 wherein the blend of micronutrients includes metal ions, and wherein the anaerobic bioreactor tank further contains means for chelating the metal ions so that the metal ions become available for the anaerobic microorganisms to take up and use.

9. The apparatus of claim 7 further comprising means for adding micronutrients to the blend at controlled doses based on a determination of the flow rate of the wastewater through the anaerobic bioreactor tank versus organic load in the wastewater.

10. The apparatus of claim 1 wherein the means for aerobic bioreaction of the organic material in the filtered wastewater comprises an aerobic bioreactor tank containing naturally occurring aerobic bacteria which digest organic material to produce non-drinkable recycled water conforming to Class A parameters.
